(19) United States
(12) Patent Application Publication
(10) Pub. No.: US 2022/0192917 A1
(43) Pub. Date: Jun. 23, 2022

(54) Cardiopulmonary Resuscitation (CPR) Device With Blood Flow Cardiopulmonary Resuscitation Value Feedback And Interface

(71) Applicant: Wolf Medical, LLC, New York, NY (US)

(72) Inventor: Blake Elliot Lopez, New York, NY (US)

(73) Assignee: Wolf Medical, LLC, New York, NY (US)

(21) Appl. No.: 17/553,769

(22) Filed: Dec. 16, 2021

Related U.S. Application Data
(60) Provisional application No. 63/173,887, filed on Apr. 12, 2021.
(60) Provisional application No. 63/126,716, filed on Dec. 17, 2020.

(51) Int. Cl. A61H 31/00

(52) U.S. Cl. CPC A61H 31/005; A61H 31/006; A61H 2230/255; A61H 2201/5048; A61H 2201/5043; A61H 2201/5007

(57) ABSTRACT

A cardiopulmonary resuscitation device with blood flow cardiopulmonary resuscitation value feedback is disclosed. The device has a blood flow sensor where a computer converts a blood flow value to a cardiopulmonary resuscitation value and provides the cardiopulmonary resuscitation value to a sensory indicator, a mechanical chest compression device or another computer, computer network, or computing device. The cardiopulmonary resuscitation value provides information on improving chest compressions during a medical emergency involving cardiopulmonary resuscitation by an emergency medical worker. The cardiopulmonary resuscitation may, in some embodiments, be aided by a mechanical chest compression device. The device improves patient outcome from cardiopulmonary resuscitation.

### CROSS REFERENCE TO RELATED PATENT APPLICATIONS

This application claims priority to U.S. Patent Application Ser. No. 63/126,716 filed on Dec. 17, 2020 entitled “Medical Device”, and U.S. Patent Application Ser. No. 63/173,887 filed on Apr. 12, 2021 entitled “Self-Adjusting Mechanical Chest Compression Device”, the entire disclosures of which are incorporated herein by reference in their entirety.

### STATEMENT REGARDING FEDERALLY SPONSORED RESEARCH OR DEVELOPMENT

### BACKGROUND OF THE INVENTION

### 1. Field of the Invention

The present invention relates generally to medical devices, and more particularly to a cardiopulmonary resuscitation (CPR) device that uses blood flow cardiopulmonary resuscitation value feedback for improving the outcome of cardiopulmonary resuscitation.

### 2. Description of the Related Art

Cardiopulmonary Resuscitation (CPR) is a very established medical procedure for reviving a patient who has suffered a medical emergency that has rendered their heart unable to pump blood. In such a situation, chest compressions are performed by an emergency medical worker to establish blood perfusion such that blood flows to vital organs and the brain with subsequent restoration of heart rhythm. Cardiopulmonary Resuscitation (CPR) is thus a life saving technique that must be performed immediately and with proper technique in order to save the life of the patient. Proper technique includes timing of the chest compression, force applied to the chest during the chest compression, location of the chest compression, as well as the amount of compressive travel during each chest compression. Unfortunately there is currently no way for the emergency medical worker to obtain feedback on the effectiveness of each chest compression, thus leaving a very undesirable element of chance to such a critical medical procedure. To make matters that much more difficult, the physiological makeup of each patient is different, and thus necessitates slightly different chest compression techniques for each patient. For example, overweight and underweight patients present very different requirements for compressive force and placement of each chest compression.

What is needed is a way to provide real time feedback on the effectiveness of chest compression being provided by an emergency medical worker such that the emergency medical worker can modify their chest compression technique so that it provides optimal blood perfusion.

What is also needed is a way to provide real time feedback on the effectiveness of chest compression being performed by a mechanical chest compression device to that mechanical chest compression device such that chest compressions being performed by the mechanical chest compression device are optimal for blood perfusion.

What is also needed is a way to provide real time information on the effectiveness of chest compressions during cardiopulmonary resuscitation to emergency medical workers and also to provide information from other sources to emergency medical workers or a mechanical chest compression device so that the chest compressions are optimal for blood perfusion.

The present invention and the various embodiments described and envisioned herein provide for such unmet needs.

### BRIEF SUMMARY OF THE INVENTION

In accordance with the present invention, there is provided a cardiopulmonary resuscitation (CPR) device that improves the outcome of cardiopulmonary resuscitation (CPR). The device uses a non-invasive blood flow sensor to determine cardiopulmonary function during CPR and in turn provides real-time feedback to the individual performing CPR on a patient. Cardiopulmonary functions may include heart rate, blood velocity, blood volume, blood pressure, and blood oxygenation. Real-time feedback is provided to the individual performing CPR by way of an audible or visual signal. A change in the characteristics of the signal (for example, with an audible signal, change in volume or frequency of the audible signal) indicates how effective or ineffective each chest compression is, and alerts the CPR provider to either continue with their course of action or change it (change placement of the chest compression, timing, depth or force of the chest compression).

In some embodiments, the blood flow sensor provides a signal to a mechanical chest compression device which in turn adjusts the chest compression or placement of the chest compressor on the patient. The mechanical chest compression device may have an X-Y rail arrangement for moving the location of the chest compressor in response to information from the blood flow sensor.

In some embodiments, the cardiopulmonary resuscitation (CPR) device is a wearable device that contains a non-invasive blood flow sensor and is capable of providing event data to an event recorder and also an alert through a network.

The foregoing has been provided by way of introduction, and is not intended to limit the scope of the invention as described by this specification, claims, and the attached drawings.

### BRIEF DESCRIPTION OF THE DRAWINGS

The invention will be described by reference to the following drawings, in which like numerals refer to like elements, and in which:

FIG. 1 depicts a block diagram of the main constituent components of a user based embodiment of the cardiopulmonary resuscitation device with blood flow cardiopulmonary resuscitation value feedback of the present invention;

FIG. 2 depicts a block diagram of the main constituent components of a wearable device embodiment of the cardiopulmonary resuscitation device with blood flow cardiopulmonary resuscitation value feedback of the present invention;

FIG. 3 depicts a block diagram of the main constituent components of a chest compression device embodiment of the cardiopulmonary resuscitation device with blood flow cardiopulmonary resuscitation value feedback of the present invention;

FIG. 4 is a data flow diagram depicting the creation of patient specific parameters;

FIG. 5 is a data flow diagram depicting a user based method for improved patient outcome;

FIG. 6 is a data flow diagram depicting a mechanical chest compression based method for improved patient outcome;

FIG. 7 is a data flow diagram depicting a further mechanical chest compression based method for improved patient outcome;

FIG. 8 is a data flow diagram depicting a feedback mechanical chest compression based method for improved patient outcome;

FIG. 9 is a perspective view of a mechanical chest compression device of the present invention;

FIG. 10 is a front view of the mechanical chest compression device of the present invention;

FIG. 11 is a back view of the mechanical chest compression device of the present invention;

FIG. 12 is a right side view of the mechanical chest compression device of the present invention;

FIG. 13 is a left side view of the mechanical chest compression device of the present invention;

FIG. 14 is a top view of the mechanical chest compression device of the present invention; and

FIG. 15 is a bottom view of the mechanical chest compression device of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims, and drawings attached hereto.

### DESCRIPTION OF THE PREFERRED EMBODIMENTS

As will be further described herein, a cardiopulmonary resuscitation device with blood flow cardiopulmonary resuscitation value feedback is disclosed.

The cardiopulmonary resuscitation device monitors blood flow non-invasively, and provides real time feedback during and/or after an emergency medical procedure. The real time feedback includes a cardiopulmonary resuscitation value that is derived from a measured blood flow value and in turn provides feedback to emergency medical personnel regarding the adequacy of their cardiopulmonary resuscitation actions. The feedback may come in a variety of forms, including audible, visual, tactile, or in some embodiments as an electronic feedback signal to a mechanical chest compression device instructing the mechanical chest compression device to take certain actions or modify certain actions. The cardiopulmonary resuscitation value is derived from a measured blood flow value as well as other patient specific parameters to provide real time feedback to emergency medical personnel resulting in optimal chest compressions. This optimization would not be possible with blood flow monitoring alone, and will be described in further detail below by reference to the drawings.

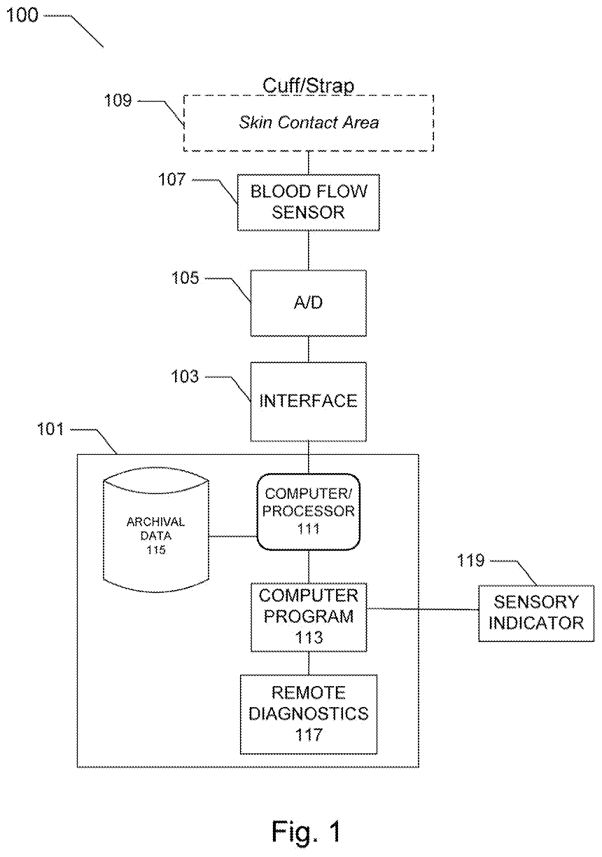

Turning first to FIG. 1, a block diagram of the main constituent components of a user based embodiment 100 of the cardiopulmonary resuscitation device with blood flow cardiopulmonary resuscitation value feedback is depicted. In this embodiment, a sensory indicator provides feedback directly to an emergency medical care provider to allow the emergency medical care provider to adjust their chest compressions based on the sensory indicator.

A blood flow sensor 107 is applied to a patient non-invasively through a cuff, a strap, a band or a similar arrangement that provides skin contact over a blood vessel. There may be a plurality of blood flow sensors configured as a strap, cuff or similar wearable arrangement. The blood flow sensors may employ photo acoustics, doppler, ultrasound, duplex doppler ultrasonography, electromagnetics, optics, laser doppler, fiber optics or the like. In addition, the blood flow sensor 107 may include pulse oximetry for determining blood oxygen saturation. In one preferred embodiment, photoacoustic doppler is used for the blood flow sensor 107.

Placement of the blood flow sensor 107 would, in one embodiment, preferably be on the brachial artery. The blood flow sensor 107 may include a clear or partially clear cuff, strap or band such that the sensors are visible to an emergency medical provider during placement, ensuring correct placement of the blood flow sensor 107 during an extremely time sensitive procedure. The blood flow sensor 107 provides rate of flow and flow velocity in real time for subsequent downstream processing. Flow velocity can also be used to determine blood pressure which is in turn provided to the computer system 101 for subsequent determination of cardiopulmonary resuscitation values. While the blood flow sensor 107 may provide an analog signal representative of blood flow velocity or volume, an analog to digital converter 105 may be employed to convert the analog signal to digital signals that are sent to the computer system 101 through an interface 103. The interface 103 may simply be a communications interface such as RS-232, RS-422, RS-485, other serial or parallel interfaces, or may employ a wireless or encrypted standard.

A computer system 101 can be seen that has a processor, memory, and access to computer readable media. The computer system 101 receives blood flow data from the interface 103 for subsequent conversion to a cardiopulmonary resuscitation value. Within the computer system 101, a computer/processor 111 executes a computer program 113 that executes the steps of retrieving a binary representation of the blood flow sensor output; converting the binary representation of the blood flow sensor output to a blood flow value; assigning the blood flow value to a cardiopulmonary resuscitation value; converting the cardiopulmonary resuscitation value to a user feedback value; and providing the user feedback value to a sensory indicator 119. In some embodiments of the present invention, the blood flow value is converted to a cardiac output value. The cardiac output value is calculated by the computer program 113 using blood flow values with sensed heart rate and estimated stroke volume. In one embodiment of the present invention, the cardiac output value is determined with Fick's Formula. The sensory indicator 119 may be an audible indicator such as a tone or a signal that changes in amplitude, frequency, or duration/cadence as the emergency medical responder performs chest compressions that are more conforming or less conforming to an optimal value as defined by cardiopulmonary resuscitation values that are provided in real time or near real time to the emergency medical responder. The sensory indicator may also provide a visual indicator for user feedback. In some embodiments the visual indicator is a light or a computer display. The computer system 101 may also send or receive remote diagnostics 117 such as, for example, medication status, medical records, archival or historical cardiovascular data, and the like.

The system may also, in some embodiments, determine blood pressure, heart rate, temperature, respiratory rate, end tidal CO₂, pH/blood gas, heart rhythm, oxygen saturation, blood glucose, and the like. In some embodiments, the system of the present invention can take an action when a value of a sensed function is exceeded or goes below a certain value.

In some embodiments the system integrates with electronic medical records, providing ease of charting and order entry. This would allow anyone involved in the patient's care to have real time updates on the patient's vitals. It would also allow ease of determining the timing of interventions such as medications, CPR, oxygen administration, defibrillation, and the like. The system may also, in some embodiments, provide medical alerts to providers when critical changes in vitals occur so that treatment is provided promptly when needed.

In its simplest form, the cardiopulmonary resuscitation is directly and linearly correlated to a blood flow value. For example, decreased blood flow results in a lower (or in some embodiments a higher) cardiopulmonary resuscitation value, which in turn relates to a lower (or in some embodiments a higher) user feedback value. Since the user feedback value is provided to a sensory indicator 119, a lower blood flow may result in a lower sensory indication (for example, a lower volume audio signal) and alternatively, a higher blood flow would result in a higher sensory indication (for example, a higher volume audio signal). The sensory indicator may also provide feedback in the form of slower or faster cadence, higher or lower pitch (sound frequency), and the like. The cardiopulmonary resuscitation value may also contain a value that corresponds to placement of the hand during compression, depth of the compression, force of the compression, and the like, and may provide user feedback for these variables as another sensory indicator (for example, light or haptics), or as a multi-dimensional audio or visual signal (where, for example, in an audio signal amplitude (volume) represents blood flow, frequency represents force of the chest compression, and cadence represents hand placement during each compression).

In some embodiments, the cardiopulmonary resuscitation value is adjusted or modified based on patient specific parameters. Patient specific parameters include, but are not limited to, patient age, patient weight, patient height, patient age, patient medication history, patient medical history, and patient cardiovascular history. With an adjusted or modified cardiopulmonary resuscitation value, the user feedback value is also modified or adjusted accordingly. While the American Heart Association recommends chest compressions at a rate of 100-120 per minute and to a depth of at least two inches, and not greater than 2.4 inches, these figures may vary based on the patient. Also, and very importantly, with current CPR procedures, there is no way for the provider of CPR to know if they are performing chest compressions properly at all.

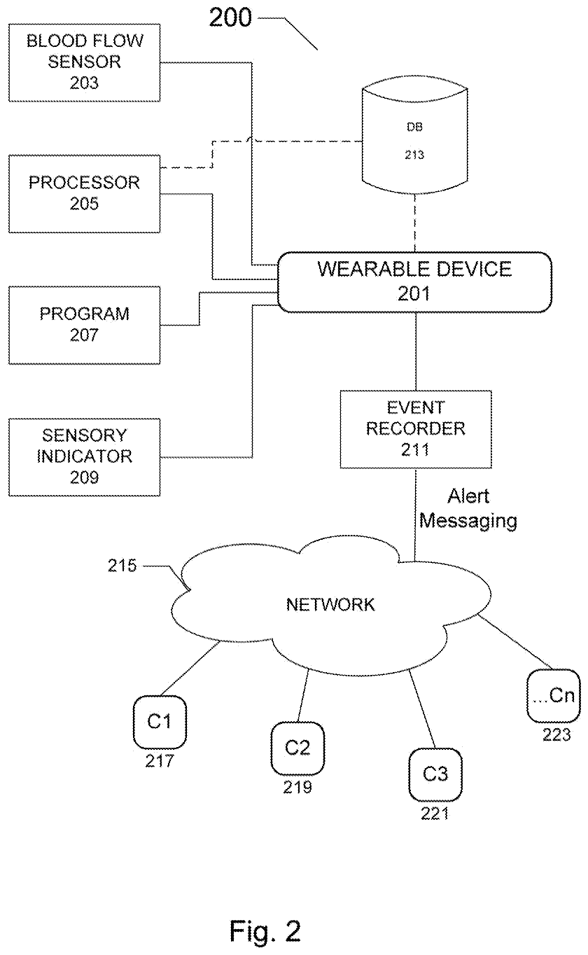

While a sensory indicator embodiment is valuable in a majority of CPR cases, a wearable device that provides blood flow feedback may provide additional or enhanced life saving utility. FIG. 2 depicts a block diagram of the main constituent components of a wearable device embodiment of the cardiopulmonary resuscitation device with blood flow value feedback. A wearable device 201 may include a watch, a chest strap, an ankle strap, a clothing item, or the like. The blood flow sensor 203 may employ a plurality of blood flow sensors of the same or different technologies. The blood flow sensors may use photo acoustics, doppler, ultrasound, electromagnetics, optics, or the like. In addition, the blood flow sensor 203 may include pulse oximetry for determining blood oxygen saturation. In one preferred embodiment, photoacoustic doppler is used for the blood flow sensor 203. In addition to a blood flow sensor 203, the wearable device 201 includes a processor 205 that executes a computer program 207 that contains the steps of retrieving a binary representation of the blood flow sensor output; converting the binary representation of the blood flow sensor output to a blood flow value; assigning the blood flow value to a cardiopulmonary resuscitation value; converting the cardiopulmonary resuscitation value to a user feedback value; and providing the user feedback value to a sensory indicator 209. The sensory indicator 209 may be an audible indicator such as a tone or a signal that changes in amplitude, frequency, or duration/cadence as the emergency medical responder performs chest compressions that are more conforming or less conforming to an optimal value as defined by cardiopulmonary resuscitation values that are provided in real time or near real time to the emergency medical responder. While one program 207 of the wearable device 201 monitors blood flow in the event of cardiopulmonary resuscitation, as previously described, a patient may also monitor blood flow with the wearable device 201 for the purpose on ongoing medical monitoring. In such a situation, an event recorder 211 may be contained in the wearable device 201, or in a networked computer or device, and is configured to send blood flow data through a network 215 to a node C1 (217) or a plurality of nodes C2 (219), C3 (221), . . . Cn (223). An optional database 213 may be included that captures event data from a patient for medical diagnostic and treatment purposes. Data sent from the wearable device to a network may be sent to, for example, a monitoring device or system to provide data to medical providers and potentially to a 911 center or the like. Data may also be sent that includes medical charts and historical medical data either to a network or to the device of the present invention or a peripheral thereof.

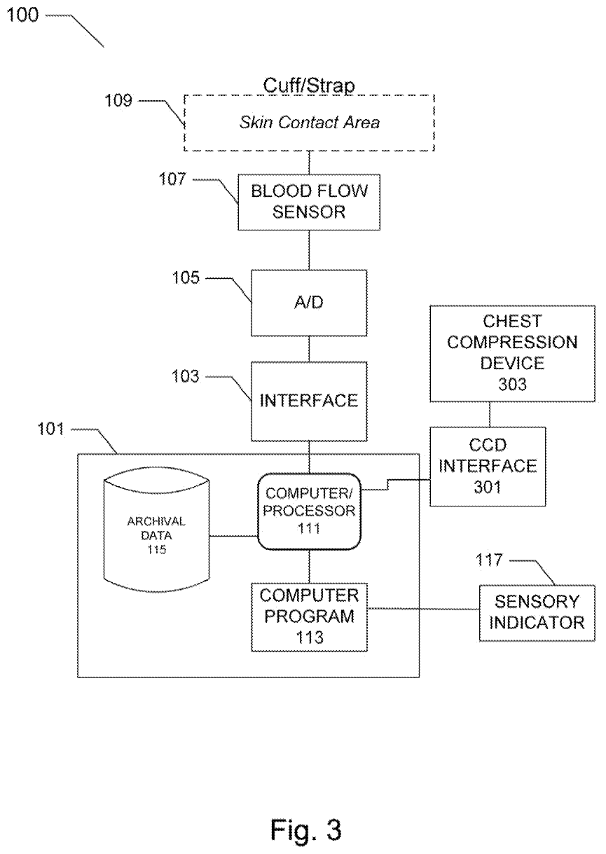

Turning now to FIG. 3 where a block diagram of the main constituent components of a chest compression device embodiment of the cardiopulmonary resuscitation device with blood flow cardiopulmonary resuscitation value feedback is depicted. The cardiopulmonary resuscitation device with blood flow cardiopulmonary resuscitation value feedback is provided with a chest compression device interface (CCD Interface 301) where the cardiopulmonary resuscitation value is converted to a chest compression value and the chest compression value is provided to a mechanical chest compression device 303. Instead of providing a sensory indicator to a user alone, the CCD interface provides information that adjusts chest compression rate, depth, force, and placement to the mechanical chest compression device 303.

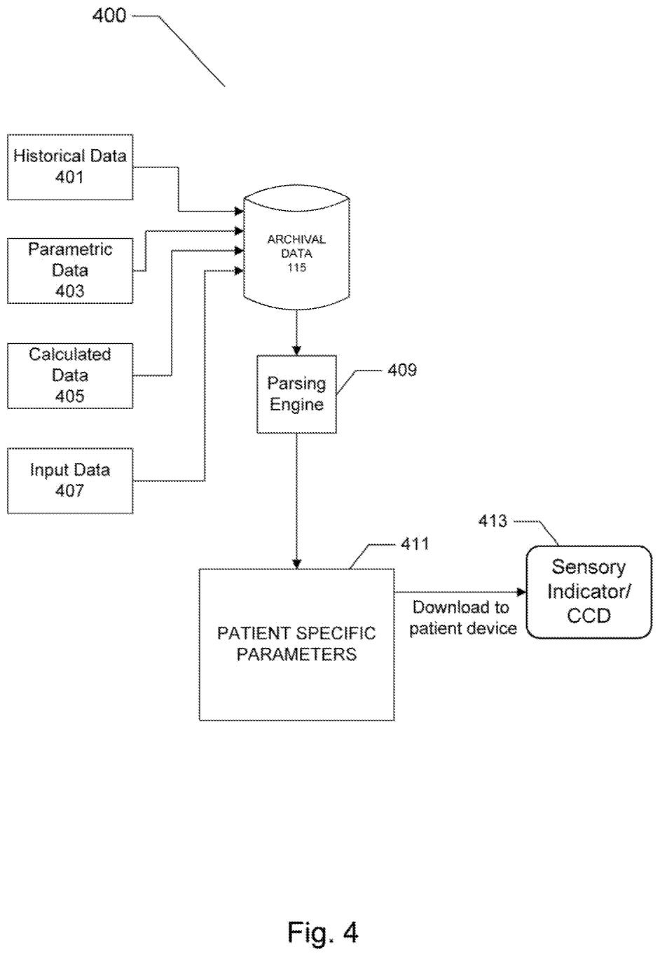

Historical or archival data from past blood flow data collections may be used to improve patient outcomes by helping to define patient specific parameters. FIG. 4 is a data flow diagram depicting the creation of patient specific parameters. As previously discussed, a database of archival data 115 comprises historical data 401 from previous patient cardiopulmonary events, parametric data 403 that defines patient specific parameters such as weight, age, and the like, calculated data 405 where data such as cardiac output is defined and determined, and input data 407 where information such as medication history or cardiovascular data is entered. This archival data 115 may be from many patients over many time intervals. A parsing engine 409 acts on this archival data to determine patient specific parameters which are then downloaded to a patient device and provided to a sensory indicator and/or a chest compression device.

While the blood flow sensor is essential for beginning the process of providing user feedback to a provider of cardiopulmonary resuscitation during a medical emergency, it is essential that blood flow values from the blood flow sensor are ultimately converted to meaningful signaling, whether that signaling is a sensory indicator or instructions provided to a mechanical chest compression device. This conversion process is software based, and performed with a processor/computer. Hemodynamics is a complex topic, and the use of software to not only convert blood flow values to useful outputs but also to modify those useful output values based on patient centric values provides for an optimal instruction set for improved patient outcome. While in its simplest form, sensing blood flow or lack of blood flow and alerting the emergency medical provider to this binary condition is a fundamental and basic component of the present invention, optimizing blood flow during cardiopulmonary resuscitation not only improves patient outcome but also reduces complications associated with lack of blood flow. Blood flow velocity can be expressed as:

V=Q/A

Where V is blood flow velocity (cm/s), Q is blood flow (ml/s) and A is cross sectional area (cm²). Blood flow can vary based on the smoothness of the vessels and other factors, thus making optimal blood flow patient specific. A preferred placement of the blood flow sensor of the present invention is the brachial artery. A blood flow value (BFV) may be expressed in ml/s or ml/min. For example, brachial artery blood flow may be 600-800 ml./min. This value is then converted to a cardiopulmonary resuscitation (CPR) value, which may be, in some embodiments, the same as the initial blood flow value (for example, a blood flow value of 800 ml/min may be assigned a CPR value of 800. This CPR value may then be acted on or modified by a variety of parameters such as patient parameters to ensure that a feedback value that indicates optimal blood flow for a given chest compression is the same regardless of the patient and differences in their hemodynamic characteristics. For example, a CPR value of 800 may indicate that optimal blood flow is occurring in patient A, whereas optimal blood flow for patient b in the brachial artery may be 700 ml/min. Thus, a CPR value for patient A may be 800 who has an optimal blood flow value of 800 ml/min. and the CPR value for patient B may also be 800 where patient B has an optimal blood flow value of 700 ml/min. For simplicity of this example, if a CPR value of 800 indicates optimal blood flow, the User Feedback Value would be greatest (for example, greatest amplitude of a tone being indicative of optimal blood flow) at a CPR value of 800. Thus, if the amplitude (volume) of a sensory indicator is greatest at a CPR value of 800, and the maximum volume of the sensory indicator is a 10 (of course these decimal numbers are arbitrary and would most likely be represented in binary as part of the computer program of the present invention), then a CPR value of 800 would be assigned a user feedback value of 10. While these numbers are arbitrary, the data flow and data conversion of this example would apply to a variety of situations of the present invention.

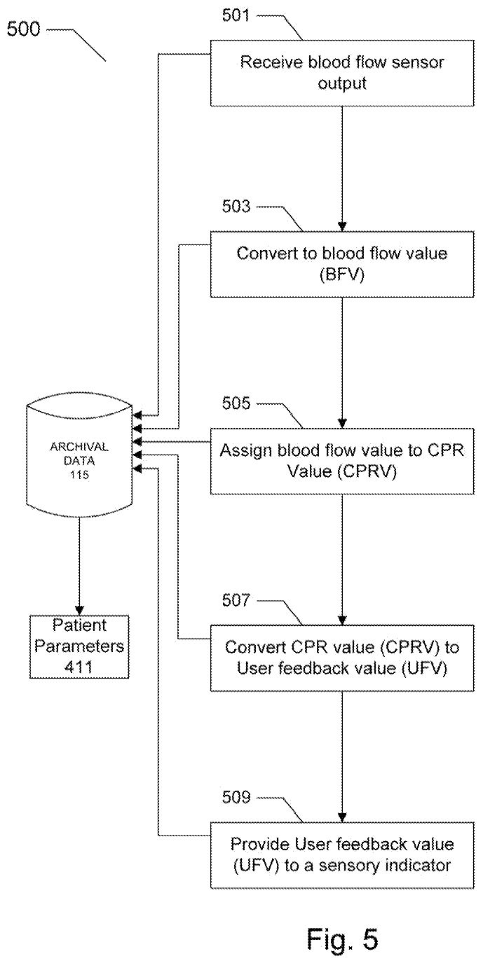

With this example in mind, an example of data flow of the present invention is provided by way of FIG. 5, which depicts a data flow diagram of a user based method for improved patient outcome 500. The data flow generally corresponds with the previously described detailed description provided herein. It should be noted that the steps in FIG. 5 are collected by a database of archival data 115 to continually improve the device of the present invention by generating patient parameters 411 that may include, for example, modification of the user feedback value or cardiopulmonary resuscitation value, administration of medications, and the like. In some embodiments, however, collection of data or archiving of data is not present. In step 501, the output of the blood flow sensor is received and converted to a blood flow value in step 503. This may, in some embodiments, involve the conversion from an analog signal to a digital signal. The blood flow value that has been determined is then used to assign a CPR Value (CPRV) to the blood flow value in step 505. The CPR Value (CPRV) is then converted to a User Feedback Value (UFV) in step 507. In step 509, the User Feedback Value (UFV) is provided to a sensory indicator such as an audible or a visual signal or signals to provide feedback to a user (a provider of cardiopulmonary resuscitation to a patient). It should be noted that these steps may be executed in plurality, and may be real time or near real time in order to provide the user with real time feedback of the effectiveness of each chest compression as well as the effectiveness of other actions that may be taken during cardiopulmonary resuscitation (such as, for example, mouth to mouth resuscitation, administration of medication, and the like). In addition, it should be noted that the calculation and definition of these values has been previously described herein by way of example, and not limitation.

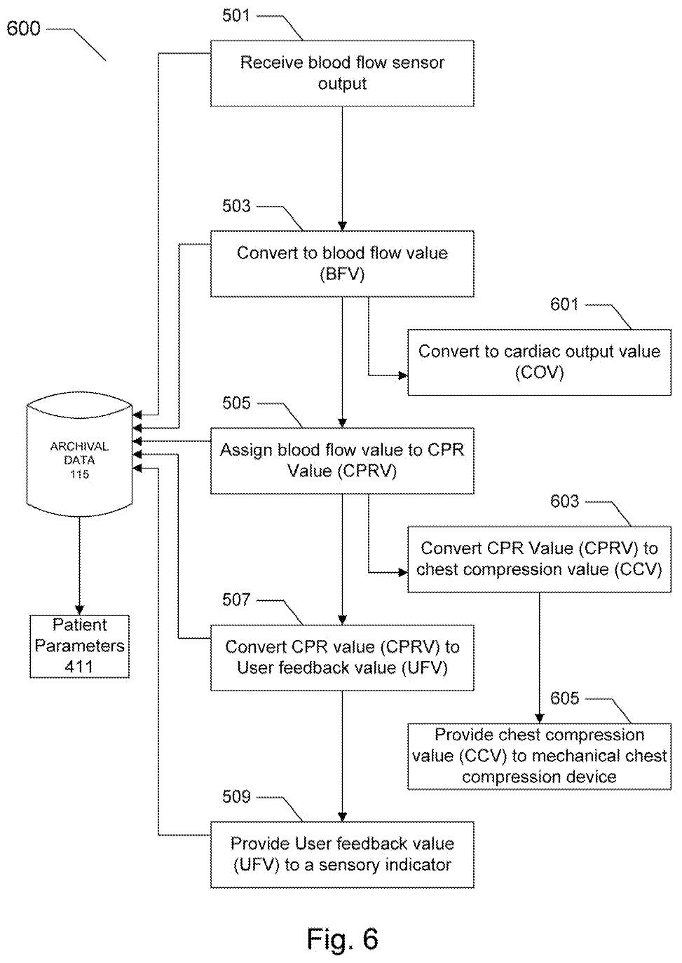

In some embodiments, a mechanical chest compression device (automated CPR machine) is included with the device for improving the outcome of cardiopulmonary resuscitation. FIG. 6 is a data flow diagram depicting a mechanical chest compression based method for improved patient outcome. In step 601, the blood flow value previously determined in step 503 is converted to a Cardiac Output Value (COV). Blood flow can be used to determine stroke volume (estimated based on blood flow measured in the artery where the blood flow sensor has been placed) and from there a cardiac output value is determined by multiplying stroke volume by heart rate (compressively induced rate for example). A Cardiac Output Value (COV) is useful to medical practitioners during and after cardiopulmonary resuscitation, and may, in some embodiments, be used to provide user feedback to a sensory indicator or control of a mechanical chest compression device. The Cardiac Output Values gathered during and after cardiopulmonary resuscitation may also be archived in a database for improved patient treatment.

In step 603, the CPR Value (CPRV) is converted to a chest compression value (CCV) and provided to a mechanical chest compression device in step 605. By providing CPR Values (CPRVs) to a mechanical chest compression device customized chest compressions and ventilation periods can be determined based on blood flow values and other inputs that may have been used to determine CPR Values. A digital interface is preferably provided that converts the stream of CPR Values being calculated in real time or near real time to digital representations (digital numerical values and perhaps additional information to supplement the CPR Values such as machine control information) that are in turn received by the mechanical chest compression device and used to modify key physical parameters such as stroke depth, stroke rate, ventilation interval and timing, and the like. In the embodiment described by way of FIG. 6, the parametric modifications made during use of the mechanical chest compression device are primarily directed at Z-axis functionality (chest compression stroke modality).

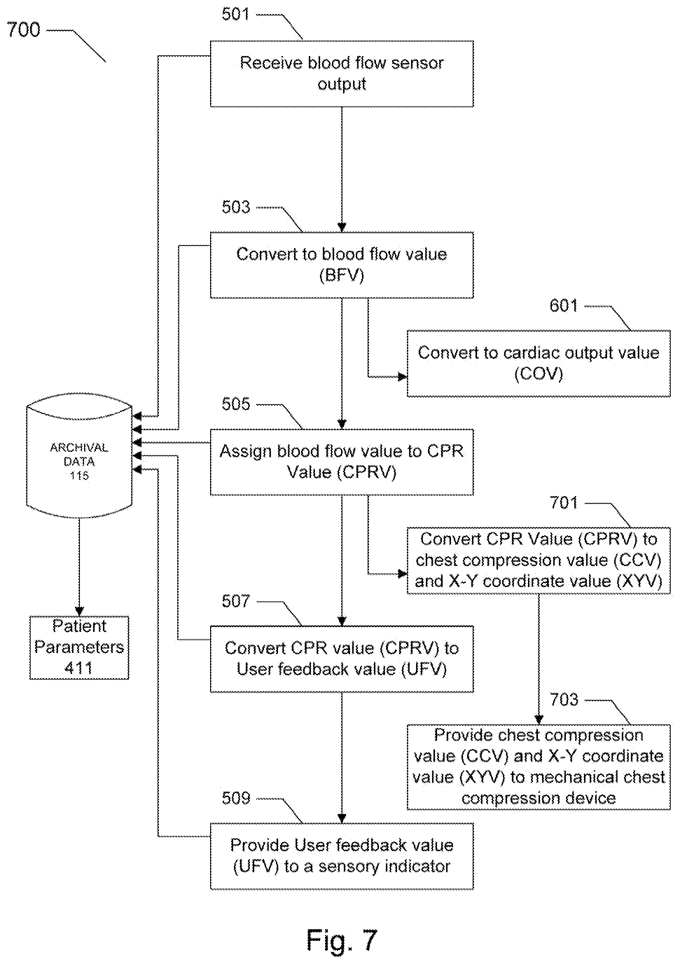

Turning now to FIG. 7, a data flow diagram depicting a further mechanical chest compression based method for improved patient outcome can be seen. In this embodiment, the mechanical chest compression device is equipped with mechanically adjustable and motorized racks, slides or scaffolding that allows the chest compression piston to be moved along both the X-axis and the Y-axis, thus adjusting the placement of the chest compression piston (plunger) on the chest of the patient. Thus, in step 701 the CPR Value (CPRV) is converted to both a Chest Compression Value (CCV) and an X-Y Coordinate Value (XYV) and in step 703 the Chest Compression Value (CCV) and XY Coordinate Value (XYV) are provided to the mechanical chest compression device. This is done in real time or near real time, with the mechanical chest compression device making adjustments in the X, Y and Z axis in real time or near real time during a CPR procedure.

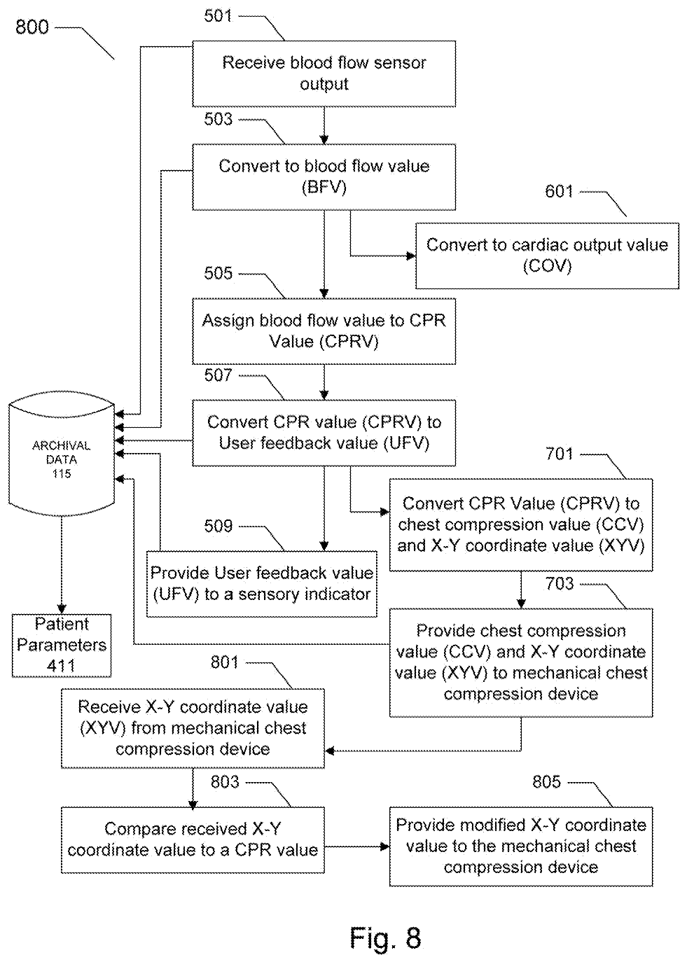

FIG. 8 depicts a data flow diagram of a feedback mechanical chest compression based method for improved patient outcome where the ongoing changes in X, Y and Z position of the mechanical chest compression device piston (plunger) are received in step 801 and compared to the ongoing stream of CPR values, resulting in the provision of modified X-Y coordinate values (and in some embodiments Z coordinate values) to the mechanical chest compression device.

Mechanical chest compression device functionality, which includes a blood flow sensor and related software and processor, may be integrated with a mechanical chest compression device or may, in some embodiments, be a detachable peripheral that is connected to the electronic unit of the mechanical chest compression device by way of a cable or a wireless interface.

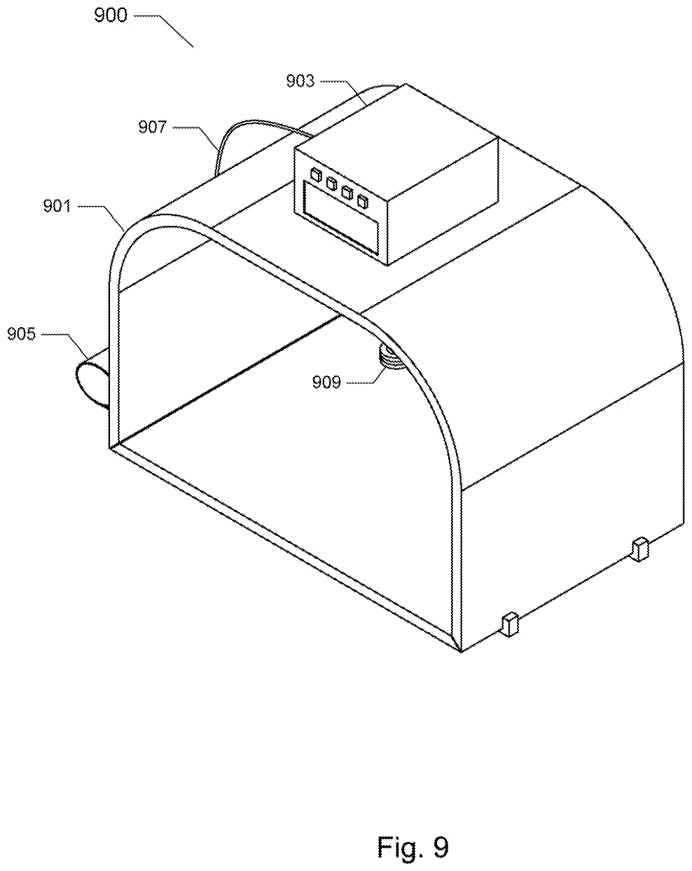

FIG. 9 is a perspective view of a mechanical chest compression device of the present invention 900. A housing and backplate 901 can be seen along with electronics controls 903. In some embodiments, the housing attaches directly to a bed or stretcher without the necessity of placing a backplate under the patient, thus saving valuable time. A blood flow sensor cuff 905 can be seen attached to a cable 907 that interfaces with the electronics controls 903. A piston (plunger) 909 can also be seen. The piston (plunger) 909 is driven be a linear device such as a linear mechanical or electrical or electromechanical actuator. In some embodiments, the actuator is pneumatic or hydraulic.

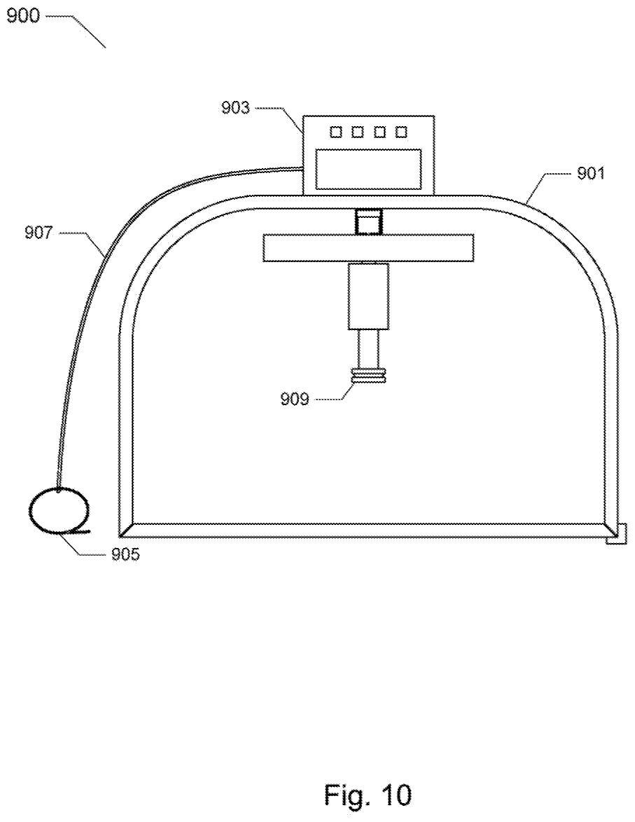

FIG. 10 is a front view of the mechanical chest compression device of the present invention 900. Above the piston (plunger) 909, an X-Y adjustment arrangement can be seen, which allows the placement of the piston (plunger) 909 to be modified based on control input derived from CPR Values (CPRVs).

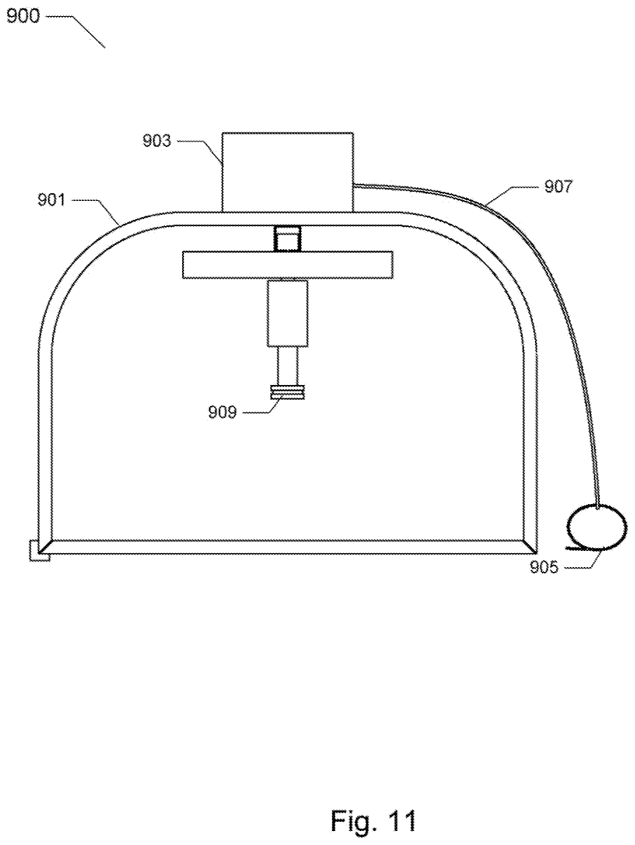

FIG. 11 is a back view of the mechanical chest compression device of the present invention showing clearly the blood flow sensor cuff 905.

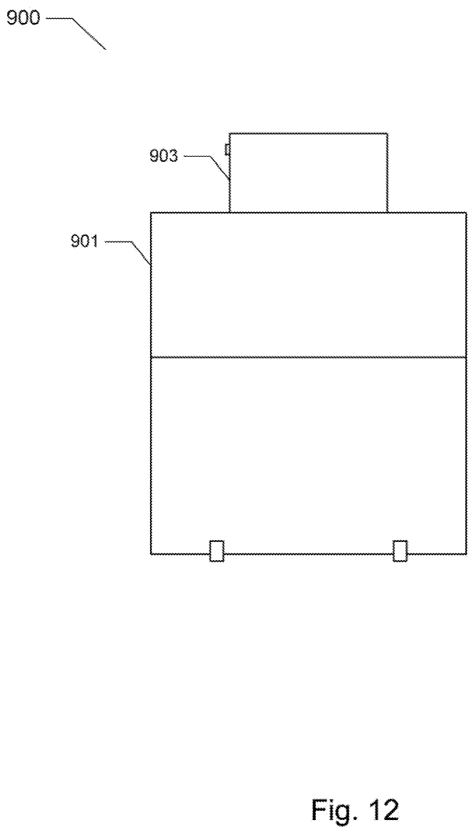

FIG. 12 is a right side view of the mechanical chest compression device of the present invention.

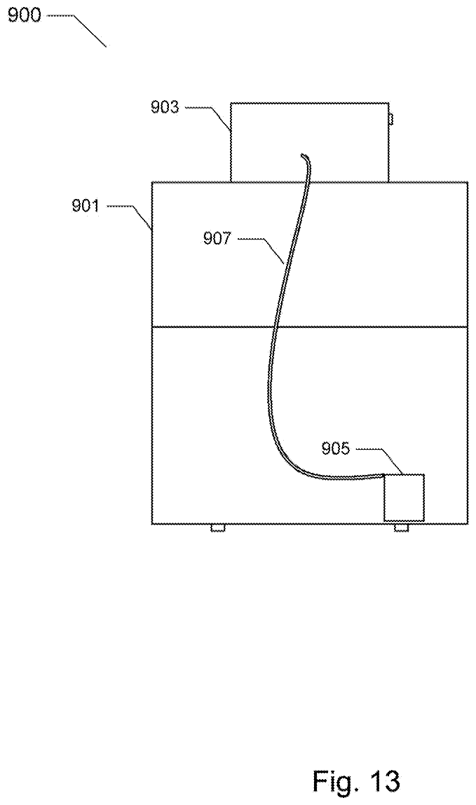

FIG. 13 is a left side view of the mechanical chest compression device of the present invention.

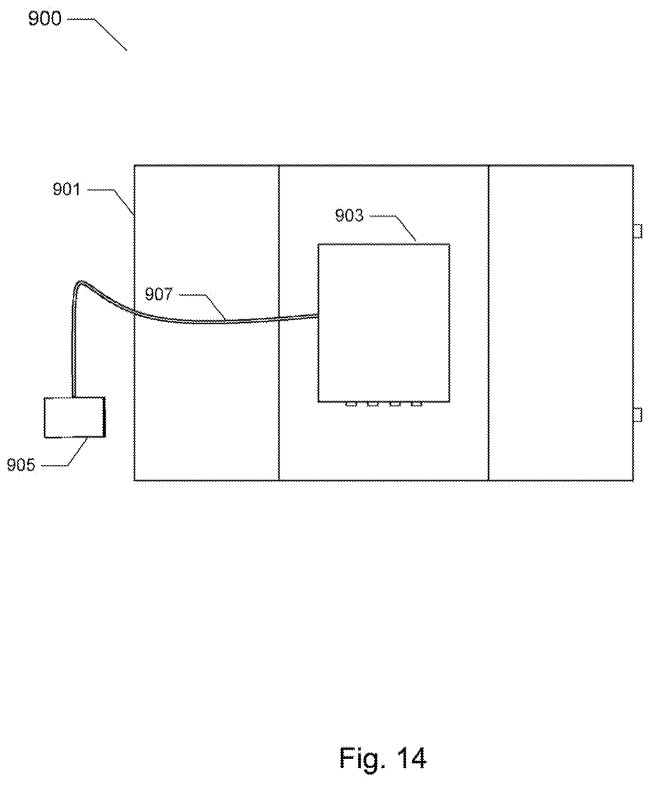

FIG. 14 is a top view of the mechanical chest compression device of the present invention.

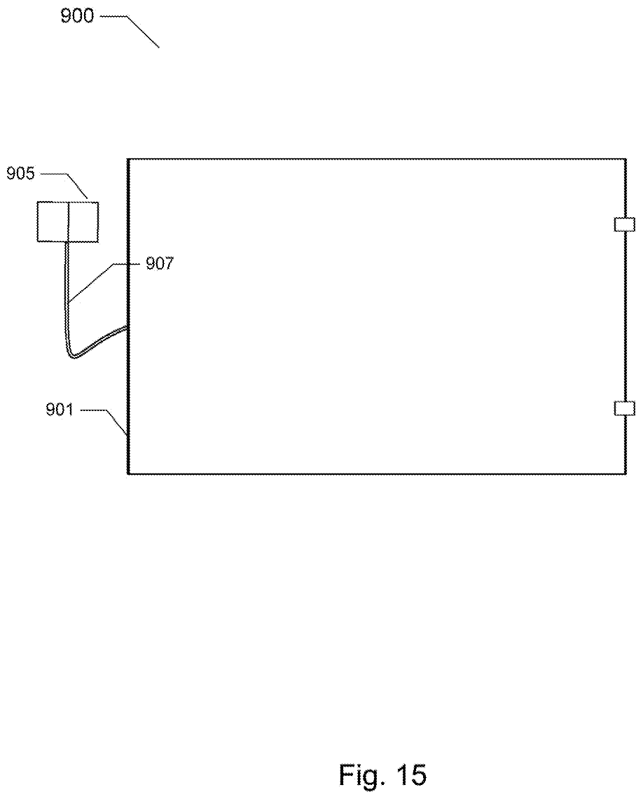

Lastly, FIG. 15 is a bottom view of the mechanical chest compression device of the present invention.

Having described and illustrated the principles, components and methods of the present invention by reference to one or more preferred embodiments, it should be apparent that the preferred embodiment(s) described and envisioned herein may be modified in arrangement and detail without departing from the spirit and broad scope of the present invention, and that these modifications and variations are to be considered and construed as being included in the present application and invention described herein.

What is claimed is:

1. A device for improving the outcome of cardiopulmonary resuscitation, the device comprising:
a blood flow sensor configured to make contact with the skin of a patient;
a housing for retaining the blood flow sensor;
and analogy to digital converter configured to received the output of the blood flow sensor and convert the output to a binary representation;
a computer having a processor, memory, access to computer readable media;
an interface configured to receive the binary representation of the blood flow sensor output from the analog to digital converter;
a computer program stored on the computer readable media where the computer program executes the steps of:
retrieving the binary representation of the blood flow sensor output;
converting the binary representation of the blood flow sensor output to a blood flow value;
assigning the blood flow value to a cardiopulmonary resuscitation value;
converting the cardiopulmonary resuscitation value to a user feedback value; and
providing the user feedback value to a sensory indicator.

2. The device for improving the outcome of cardiopulmonary resuscitation as recited in claim 1, wherein the blood flow sensor is a photoacoustic doppler sensor.

3. The device for improving the outcome of cardiopulmonary resuscitation as recited in claim 1, wherein the housing is a strap for placement around a body part of a patient.

4. The device for improving the outcome of cardiopulmonary resuscitation as recited in claim 3, wherein the strap has a visual aperture to allow a user to determine proper placement of the sensor.

5. The device for improving the outcome of cardiopulmonary resuscitation as recited in claim 1, wherein the sensory indicator is a sound that varies in frequency based on the user feedback value at a given point in treatment time.

6. The device for improving the outcome of cardiopulmonary resuscitation as recited in claim 1, wherein the sensory indicator is a sound that varies in amplitude based on the user feedback value at a given point in treatment time.

7. The device for improving the outcome of cardiopulmonary resuscitation as recited in claim 1, wherein the sensory indicator is a sound that varies in both frequency and amplitude based on the user feedback value at a given point in treatment time.

8. The device for improving the outcome of cardiopulmonary resuscitation as recited in claim 1, wherein the sensory indicator is a visual indicator.

9. The device for improving the outcome of cardiopulmonary resuscitation as recited in claim 8, wherein the visual indicator is a computer display.

10. The device for improving the outcome of cardiopulmonary resuscitation as recited in claim 8, wherein the visual indicator is a light source.

11. A device for improving the outcome of cardiopulmonary resuscitation, the device comprising:
a blood flow sensor configured to make contact with the skin of a patient;
a housing for retaining the blood flow sensor;
a mechanical chest compression device comprising a digital interface configured to receive a chest compression value;
an analog to digital converter configured to receive the output of the blood flow sensor and convert the output to a binary representation;
a computer having a processor, memory, and access to computer readable media;
an interface configured to receive the binary representation of the blood flow sensor output from the analog to digital converter;
a computer program stored on the computer readable media where the computer program executes the steps of:
retrieving the binary representation of the blood flow sensor output;
converting the binary representation of the blood flow sensor output to a blood flow value;
assigning the blood flow value to a cardiopulmonary resuscitation value;
converting the cardiopulmonary resuscitation value to a chest compression value; and
providing the chest compression value to the mechanical chest compression device.

12. The device for improving the outcome of cardiopulmonary resuscitation as recited in claim 11, wherein the blood flow sensor is a photoacoustic doppler sensor.

13. A mechanical chest compression device, the device comprising:
a body housing:
a back plate;
a chest compressor comprising a piston, an x-axis rail, a y-axis rail, and a compression head;
a computer having a processor, memory, and access to computer readable media;
an interface configured to provide the coordinates of the x-axis rail and the y-axis rail and receive instructions to change the coordinates of the x-axis rail and the y-axis rail; and
a device for improving the outcome of cardiopulmonary resuscitation, the device comprising:
a blood flow sensor configured to make contact with the skin of a patient;
a housing for retaining the blood flow sensor;
an analog to digital converter configured to receive the output of the blood flow sensor and convert the output to a binary representation;
a computer having a processor, memory, and access to computer readable media;
an interface configured to receive the binary representation of the blood flow sensor output from the analog to digital converter;
a computer program stored on the computer readable media where the computer program executes the steps of:
retrieving the binary representation of the blood flow sensor output;
converting the binary representation of the blood flow sensor output to a blood flow value;
assigning the blood flow value to a cardiopulmonary resuscitation value;
converting the cardiopulmonary resuscitation value to a chest compression value; and
providing the chest compression value to the mechanical chest compression device.

14. The mechanical chest compression device as recited in claim 13, wherein the computer program stored on computer readable media further comprises the steps of:
converting the cardiopulmonary resuscitation value to an X-Y coordinate value;
providing the X-Y coordinate value to the mechanical chest compress on device.

15. The mechanical chest compression device as recited in claim 13, wherein the computer program stored on computer readable media further comprises the steps of:
receiving an X-Y coordinate value from the mechanical chest compression device;
comparing the X-Y coordinate value to a cardiopulmonary resuscitation value;
and providing a modified X-Y coordinate value to the mechanical chest compression device.

16. The mechanical chest compression device as recited in claim 13, wherein the computer program stored on computer readable media further comprises the steps of:
converting the cardiopulmonary resuscitation value to a user feedback value; and
providing the user feedback value to a sensory indicator.

17. The mechanical chest compression device as recited in claim 16, wherein the sensory indicator is an audible indicator.

18. The mechanical chest compression device as recited in claim 16, wherein the sensory indicator is a visual indicator.

19. The mechanical chest compression device as recited in claim 13, wherein the blood flow sensor is a photoacoustic doppler sensor.

20. The mechanical chest compression device as recited in claim 13, wherein the chest compressor further comprises a z-axis rail.
